(19) United States
(12) Patent Application Publication
(10) Pub. No.: US 2013/0051951 A1
(43) Pub. Date: Feb. 28, 2013

(54) Scribing Tool and Dust Collector

(71) Applicant: William Robert Friegang, San Jose, CA (US)

(72) Inventor: William Robert Friegang, San Jose, CA (US)

(21) Appl. No.: 13/216,011

(22) Filed: Aug. 23, 2011

(51) Int. Cl. B27G 3/00; B27C 5/10

(52) U.S. Cl. 409/137; 144/252.1

(57) ABSTRACT

Scribing tool and dust collector for a router having a horizontally extending body which attaches to the router with a router bit extending along an axis of rotation through the body and projecting from a lower surface of the body for cutting engagement with an edge of a workpiece, a guide wheel mounted on the upper portion of the body for rotation about the axis, with an outer portion of the wheel projecting laterally from the body for engagement with a surface having a contour to be transferred to the edge of the workpiece by the router bit, a vacuum chamber within the body, an inlet port centered about the axis of rotation communicating with the vacuum chamber through a lower wall of the body, and a vacuum port communicating with the vacuum chamber for connection to a vacuum source to draw dust and chips produced by the router bit through the inlet port and into the chamber.

### BACKGROUND OF THE INVENTION

Field of Invention

This invention pertains generally to routers and, more particularly, to a scribing tool and dust collector for use with an offset router.

Related Art

Routers have been used by cabinetmakers for many years to trim laminates and otherwise prepare the edges of cabinets and counter tops where they abut against a wall or other surface. In some applications, the edges of the router base are used as a scribing guide which is drawn along the wall or other surface to impart the contour of the surface to the edge of the workpiece that will abut against it. Routers specifically designed for such use are commonly referred to as “offset routers” and have their cutters or bits offset from the motor axis toward the rounded or pointed nose of the router base.

U.S. Pat. No. 5,013,196 shows a scribing tool or accessory which is attached to an offset router for use in trimming the edges of laminates or other workpieces to match the contours of walls or other surfaces against which the edges will abut. As with other routers, the large amounts of sawdust and chips thrown into the air by the router bit can pose a hazard to the operator and to others in the area, as well as needing to be cleaned up.

### OBJECTS AND SUMMARY OF THE INVENTION

It is, in general, an object of the invention to provide a new and improved scribing tool and dust collector for an offset router.

Another object of the invention is to provide a scribing tool and dust collector of the above character which overcomes the limitations and disadvantages of scribing tools and routers heretofore provided.

These and other objects are achieved in accordance with the invention by providing a scribing tool and dust collector for a router having a horizontally extending body which attaches to the router with a router bit extending along an axis of rotation through the body and projecting from a lower surface of the body for cutting engagement with an edge of a workpiece, a guide wheel mounted on the upper portion of the body for rotation about the axis, with an outer portion of the wheel projecting laterally from the body for engagement with a surface having a contour to be transferred to the edge of the workpiece by the router bit, a vacuum chamber within the body, an inlet port centered about the axis of rotation communicating with the vacuum chamber through a lower wall of the body, and a vacuum port communicating with the vacuum chamber for connection to a vacuum source to draw dust and chips produced by the router bit through the inlet port and into the chamber.

### BRIEF DESCRIPTION OF THE DRAWINGS

FIG. 1 is a side elevational view of one embodiment of a router with a scribing tool and dust collector according to the invention.

FIG. 2 is a top plan view of the scribing tool and dust collector in the embodiment of FIG. 1.

FIG. 3 is a cross-sectional view taken along line 3-3 of FIG. 2.

FIG. 4 is a cross-sectional view taken along line 4-4 of FIG. 3.

FIG. 5 is a side elevational view of another embodiment of a router with a scribing tool and dust collector according to the invention.

FIG. 6 is a vertical sectional view of the scribing tool and dust collector in the embodiment of FIG. 5.

FIG. 7 is a cross-sectional view taken along line 7-7 of FIG. 6.

### DETAILED DESCRIPTION

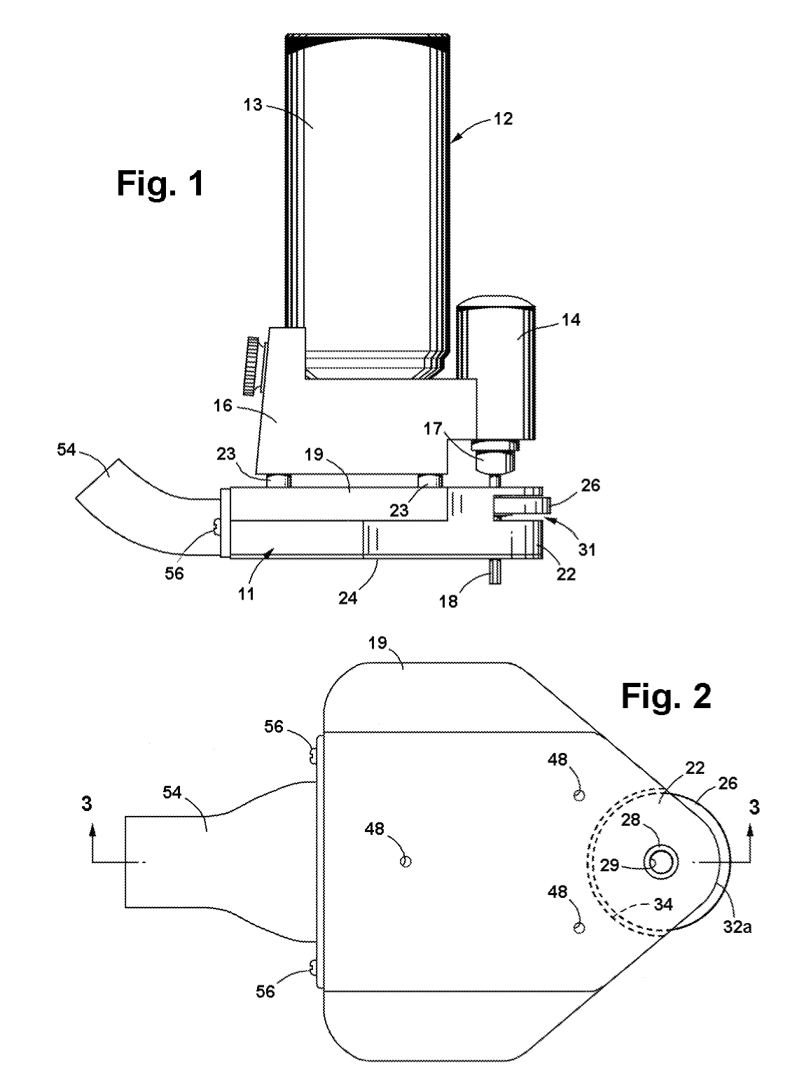

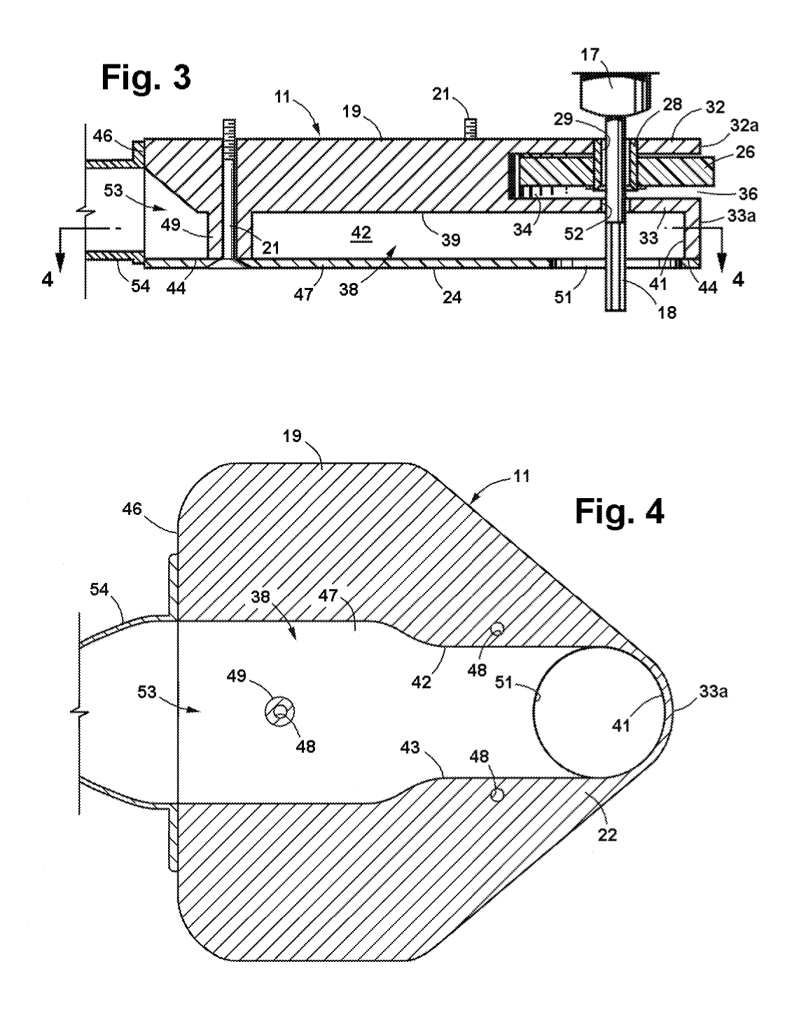

In the embodiment of FIGS. 1-4, the scribing tool and dust collector 11 is illustrated in conjunction with a router 12 having a motor housing 13 and a drive mechanism 14. mounted on a base 16. The drive mechanism is offset laterally from the motor housing toward the front of the base and includes a chuck 17 in which a router bit 18 is received.

The scribing tool and dust collector has a horizontally extending body 19 which is attached to the base of the router by mounting screws 21, with a rounded nose portion 22 of the body beneath the drive mechanism and the mounting screws being received in mounting pads 23 on the lower side of the router base. The body has a generally planar lower surface 24 for engagement with the upper surface of a workpiece (not shown), with the router bit extending through the body and projecting from the lower surface for cutting engagement with an edge of the workpiece.

A guide wheel 26 is rotatively mounted in the nose portion of the body, with an outer portion of the wheel projecting laterally for engagement with a surface having a contour to be transferred to the edge portion of the workpiece by the router bit. The guide wheel is disposed coaxially of the router bit and is rotatively mounted on an axle or shaft 28 which is affixed to the body and has an axial bore 29 through which the router bit passes. The guide wheel is mounted in an open pocket 31 having horizontally extending upper and lower walls 32, 33, an arcuately curved rear wall 34, and an open front 36, with the shaft being affixed to the upper wall or flange and extending downwardly along the axis of rotation.

The upper and lower walls of the guide wheel pocket have arcuately curved outer edges 32a, 33a with a radius of curvature less than that of the guide wheel centered about the axis of rotation. Rear wall 34 likewise has a radius of curvature centered about the axis of rotation, but that radius is greater than the radius of the wheel to provide clearance between the wheel and the wall.

A vacuum chamber 38 is formed in the body below the guide wheel. This chamber extends horizontally between the rounded nose portion and the rear edge of the body, with lower surface of the lower wall 33 of the guide wheel pocket being part of the upper wall 39 of the chamber. The chamber has an arcuately curved front wall 41 disposed concentrically of outer edges 32a, 33a and generally parallel side walls 42, 43 which extend tangentially from the front wall. The chamber opens through the lower side 44 and the rear edge 46 of the body, with a bottom plate 47 affixed to the lower side of the body forming the lower wall of the chamber.

Mounting screws 21 pass through clearance holes 48 in body and are threaded into the mounting pads on the base of the router, with a mounting post or spacer 49 supporting the bottom plate where one of the screws passes through the chamber. In the embodiment illustrated, the bottom plate is affixed to the lower side of the body by mounting screws 21. However, it can also be secured to the body by other mounting screws (not shown), or it can be permanently affixed to the body.

An inlet port 51 is formed in the bottom plate to provide communication between the area in where the chips and dust are generated and the chamber. This port is centered about the axis of rotation and is substantially greater in diameter than the router bit so that the chips and dust can pass freely through it. Where the router bit passes through the upper wall of the chamber, the opening 52 is only slightly larger than the bit to minimize the passage of chips and dust through it.

An exhaust port 53 is formed where the rear end portion of the chamber opens through the edge of the body, and a vacuum fitting 54 is attached to the rear edge by mounting screws 56 for connection to suitable source of vacuum such as a central dust collection system in a workshop, a shop vac, or other portable vacuum cleaner. Since the tool will be used primarily on jobsites, it will probably be used most often with portable vacuum cleaners.

In use, the scribing tool and dust collector is attached to the router, with the router bit 18 extending through inlet port 51 and vacuum fitting 54 connected to a source of vacuum. The workpiece is clamped or otherwise secured with the edge to be trimmed spaced from the surface against which it will abut by a distance less than the distance between the outer edge of guide wheel 26 and the inside cutting edge of router bit 18. The router is then drawn along the edge of the workpiece with guide surface 24 in contact with the workpiece, guide wheel 26 in contact with the surface having the contour to be duplicated, and the router bit cutting the edge of the workpiece to match that contour.

The vacuum or suction pressure applied to the exhaust port by the vacuum system causes a rapid flow of air through the chamber from outside the inlet port, and as the router bit trims the edge of the workpiece, the chips and dust produced by the cutter are entrained in the flow of air and carried into and through the chamber to a storage container in the vacuum system.

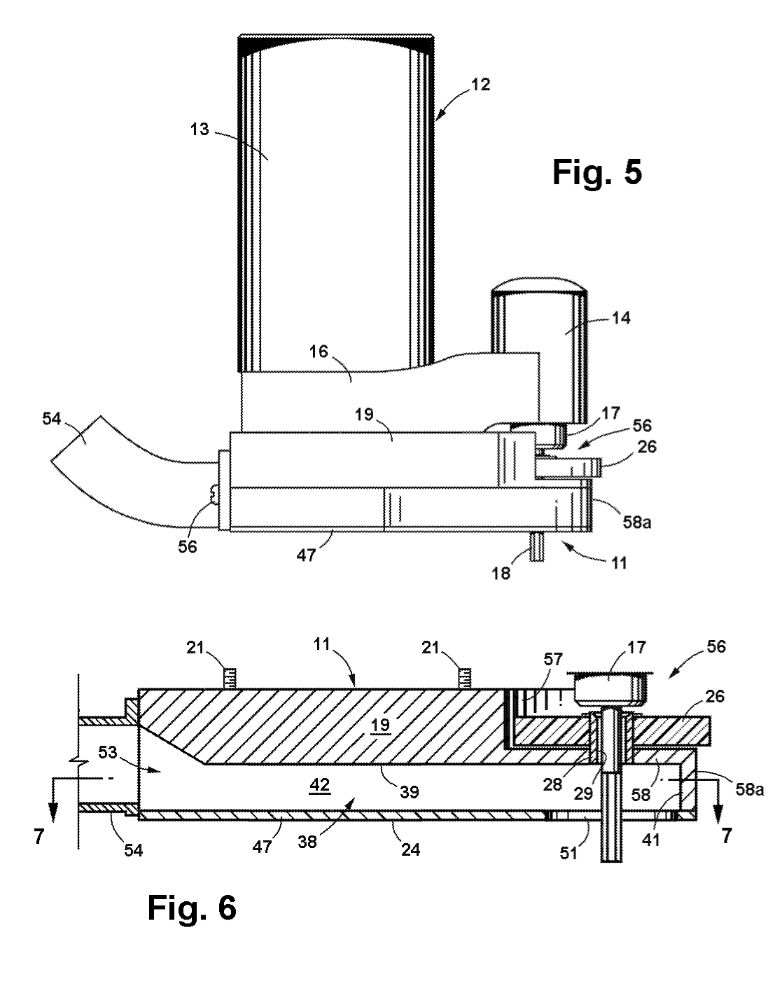

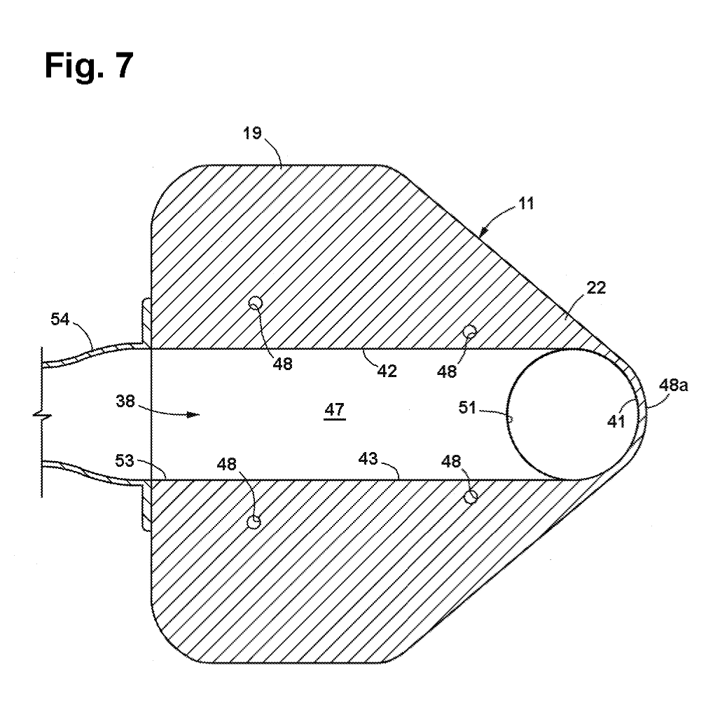

The embodiment of FIGS. 5-7 is generally to the embodiment of FIGS. 1-4, but is designed to fit a different brand of router, and like reference numerals designate corresponding elements in the two embodiments.

In the embodiment of FIGS. 5-7, there are four mounting screws 21, and they all pass through solid parts of the body to the sides of the vacuum chamber. Guide wheel 26 is mounted in a recessed area 56 on the upper side of nose portion 22. The recessed area has an arcuately curved rear wall 57 and a generally planar bottom wall 58 with an arcuately curved outer edge 58a. The recessed area overlies the front end portion of the vacuum chamber, with both rear wall 57 and outer edge 58a being centered about the axis of rotation of the router bit and the guide wheel. The radius of curvature of the rear wall is somewhat greater than that of the guide wheel so there is clearance between the wall and the wheel, whereas the radius of curvature of the outer edge is less than that of the guide wheel, with the outer portion of the wheel projecting beyond the front portion of the body.

As in the first embodiment, guide wheel 26 is rotatively mounted on an axle or shaft 28 which is affixed to the nose portion of the body. However, in this embodiment, the shaft is affixed to the bottom wall of the recessed area and extends upwardly along the axis of rotation, with the router bit 18 once again passing freely through the axial bore 29 in the shaft.

Operation and use of the embodiment of FIGS. 5-7 is similar to that of the first embodiment. The scribing tool and dust collector is attached to the router, with the router bit 18 extending through inlet port 51 and vacuum fitting 54 connected to a source of vacuum. The workpiece is set up as before, with the edge to be trimmed facing the surface against which it will abut. As the router is drawn along the edge of the workpiece with guide wheel 26 in contact with the surface, the contour of the surface is transferred to the edge of the workpiece by the router bit.

As in the vacuum or suction pressure applied to the exhaust port by the vacuum system causes a rapid flow of air through the chamber from outside the inlet port, and as the router bit trims the edge of the workpiece, the chips and dust produced by the cutter are entrained in the flow of air and carried into and through the chamber to a storage container in the vacuum system.

The invention has a number of important features and advantages, both in providing a quick and easy way to trim the edges of workpieces to precisely match the contours of adjacent surfaces and in safely and effectively collecting dust and chips produced by the router bit to eliminate the hazzards they present to the operator and to others in the area. By minimizing airborne dust, the dust collector allows the tool to be used in environments where routers might otherwise not be used.

It is apparent from the foregoing that a new and improved scribing tool and dust collector has been provided. While only certain presently preferred embodiments have been described in detail, as will be apparent to those familiar with the art, certain changes and modifications can be made without departing from the scope of the invention as defined by the following claims.

1. A scribing tool and dust collector for use with a router, comprising a horizontally extending body which attaches to the router with a router bit extending along an axis of rotation through the body and projecting from a lower surface of the body for cutting engagement with an edge of a workpiece, a guide wheel mounted on the upper portion of the body for rotation about the axis, with an outer portion of the wheel projecting laterally from the body for engagement with a surface having a contour to be transferred to the edge of the workpiece by the router bit, a vacuum chamber within the body, an inlet port centered about the axis of rotation communicating with the vacuum chamber through a lower wall of the body, and a vacuum port communicating with the vacuum chamber for connection to a vacuum source to draw dust and chips produced by the router bit through the inlet port and into the chamber.

2. The scribing tool and dust collector of claim 1 wherein the body includes a rounded nose portion from which the outer portion of the guide wheel extends, with the guide wheel being rotatively mounted on a shaft that extends along the axis of rotation and is affixed to the nose portion.

3. The scribing tool and dust collector of claim 2 wherein the guide wheel is positioned between an upper flange of the nose portion and an upper wall of the vacuum chamber.

4. The scribing tool and dust collector of claim 3 wherein the shaft is affixed to the flange.

5. The scribing tool and dust collector of claim 2 wherein the guide wheel is disposed in a recessed area on the upper side of the nose portion, with a bottom wall separating the recessed area from the vacuum chamber and the shaft being affixed to the bottom wall.

6. The scribing tool and dust collector of claim 2 wherein the shaft has an axial bore through which the router bit passes.

7. The scribing tool and dust collector of claim 2 wherein the nose portion has an arcuately extending outer edge which is centered about the axis of rotation and of lesser diameter than the guide wheel.

8. The scribing tool and dust collector of claim 1 wherein the inlet port is of substantially greater diameter than the router bit.

9. A scribing tool and dust collector for use with a router, comprising a horizontally extending body which attaches to the router and has a generally planar surface for engagement with a workpiece, with a router bit projecting from the generally planar surface for cutting engagement with an edge of the workpiece, a guide wheel mounted in a nose portion of the body for rotation about the axis of the router bit, with an outer portion of the wheel projecting laterally from the body for engagement with a surface having a contour to be transferred to the edge of the workpiece by the router bit, an elongated vacuum chamber within a portion of the body below the guide wheel, an inlet port of substantially greater diameter than the router bit centered about the axis of the router bit and opening between a first end portion of the chamber and the generally planar surface of the body, and a vacuum port communicating with a second end portion of the chamber for connection to a vacuum source to draw dust and chips produced by the router bit through the inlet port and into the chamber.

10. The scribing tool and router bit of claim 9 wherein the first end portion of the vacuum chamber has a curved end wall which extends along one side of the inlet port.

11. The scribing tool and router bit of claim 10 wherein the vacuum chamber has a pair of generally parallel side walls which are tangential to the end wall.

12. The scribing tool and router bit of claim 9 wherein the second end portion of the vacuum chamber opens through an edge of the body opposite the nose portion.

13. The scribing tool and dust collector of claim 9 wherein the guide wheel is positioned between a flange in the nose portion and a wall of the vacuum chamber.

14. The scribing tool and dust collector of claim 13 wherein the guide wheel is rotatively mounted on a shaft affixed to the flange.

15. The scribing tool and dust collector of claim 9 wherein the guide wheel is disposed in a recessed area in the nose portion, with a wall separating the recessed area from the vacuum chamber, and the guide wheel is rotatively mounted on a shaft affixed to the wall.
